(19) United States
(12) Patent Application Publication
(10) Pub. No.: US 2026/0006385 A1
(43) Pub. Date: Jan. 1, 2026

(54) Coil and Speaker Module Using Same

(71) Applicant: AAC Microtech (Changzhou) Co., Ltd., Changzhou City (CN)

(72) Inventor: Chao Zhang, Changzhou (CN)

(21) Appl. No.: 19/006,313

(22) Filed: Dec. 31, 2024

Related U.S. Application Data
(63) Continuation of application No. PCT/CN2024/101792, filed on Jun. 27, 2024.

(51) Int. Cl. H04R 9/04; H01F 5/06; H01F 27/28; H04R 7/06; H04R 7/18; H04R 9/02; H04R 9/06

(52) U.S. Cl. CPC H04R 9/046; H01F 27/2823; H04R 7/06; H04R 7/18; H04R 9/025; H04R 9/06; H01F 5/06; H04R 2400/11

(57) ABSTRACT

The present invention provides a coil and a speaker module. The coil of the present invention includes N layers of winding layers wound around a first axis from the inside to the outside, where N is an integer greater than 1, and the adjacent winding layers are connected by winding switching sections. The winding switching sections along the projection on a plane perpendicular to the first axis do not overlap with each other, thereby avoiding a concentrated arrangement in the thickness direction of the coil, reducing the overall thickness of the coil, reducing the magnetic gap, and improving the conversion efficiency and sensitivity of the speaker components used in the speaker module.

### TECHNICAL FIELD

The present invention relates to the technical field of electro-acoustic transducer devices, specifically involving a coil and a speaker module incorporating such a coil.

### BACKGROUND

As shown in FIGS. 1-2, the coil of the speaker module in the related technology is composed of N layers of winding layers 210 arranged from the inside out. Due to the fact that the N layers of winding layers 210 are made by winding a single enameled wire, a winding switch section is formed when switching from the N-th layer to the N+1-th layer during the winding process. The winding switch section of the coil is centrally located from the inside to the outside in the corresponding areas, causing the wall thickness of the coil and the winding switch section corresponding area to increase due to the superposition from the inside to the outside during the layer switching, occupying more magnetic air gap space and affecting the magnetic air gap, thereby reducing the sensitivity of the speaker module.

Therefore, it is necessary to provide a coil that can reduce the impact on the magnetic gap, enhance the sensitivity of the speaker module, and have the speaker module with the coil.

### SUMMARY

The purpose of the present invention is to provide a coil and speaker module to improve the compactness of the coil's structure, reduce the impact of the coil on the magnetic gap, and enhance the sensitivity of the speaker module with the coil.

To achieve the above purposes, the present invention provides a coil for a speaker module, including N layers of winding layers wound from an inside to an outside around a first axis, where N is an integer greater than 1. Adjacent winding layers are connected by winding switch sections, the winding switch sections are scattered along a winding path of the coil, and each winding switch section along a projection of the first axis on a plane perpendicular to the first axis does not overlap with another.

In addition, the winding switching section is dispersedly arranged in the same plane perpendicular to the first axis.

In addition, the coil as a whole is square-shaped, including long sides and short sides connected between the long sides, and the winding switching section is located on the long side of the coil.

In addition, the winding layer is connected from the inside to the outside for forming the coil body, and the coil further includes a coil input end and a coil output end respectively connected to the two ends of the coil body.

In addition, the coil is wound with enameled wire, and a conductor core of the enameled wire is made of copper core, aluminum core, copper-aluminum alloy core, or copper-clad aluminum wire.

In addition, a diameter of the conductive wire core is 0.02-0.15 mm, and an insulation thickness of the enameled wire is less than or equal to 0.02 mm.

The present invention further provides a speaker module, including a frame, a vibration system, and a magnetic circuit system accommodated in the frame. The vibration system includes a coil including N layers of winding layers wound from an inside to an outside around a first axis, where N is an integer greater than 1. And, adjacent winding layers are connected by winding switch sections, the winding switch sections are scattered along a winding path of the coil, and each winding switch section along a projection of the first axis on a plane perpendicular to the first axis does not overlap with another.

Further, the magnetic circuit system comprises a upper yoke plate, a lower yoke plate spaced from the upper yoke plate, an inner magnet, a pole core, an outer magnet arranged on the lower yoke plate, and an edge magnet arranged along a circumference of the inner magnet, for forming a magnetic gap between the inner magnet and the edge magnet for disposing the coil; and the inner magnet, the pole core, and the outer magnet are successively arranged on the lower yoke plate from a bottom to a top.

Further, the vibration system further comprises an inner diaphragm located above the outer magnet, a frame located at an outer periphery of the inner diaphragm, an upper diaphragm arranged along an outer periphery of the frame, a flexible circuit board located below the upper diaphragm, and a lower diaphragm located below the flexible circuit board, wherein the flexible circuit board communicates with the coil, the frame is connected to the flexible circuit board for supporting the vibration system on the flexible circuit board.

Compared with the related art, adjusting the position of the winding switch sections formed between adjacent winding layers of the coil of the present invention, so that the winding switch sections are staggered and the projections of each winding switch portion along a first axis on a plane perpendicular to the first axis do not overlap, the dispersed arrangement of the winding switch sections avoids concentrated arrangement in the thickness direction of the coil, reduces the overall wall thickness of the coil, reduces the magnetic air gap, and improves the conversion efficiency and sensitivity of the speaker component when applied to the speaker component.

### BRIEF DESCRIPTION OF THE DRAWINGS

In order to more clearly explain the technical solutions in the embodiments of the present application, the following will briefly introduce the drawings required in the embodiments or exemplary technical descriptions. Obviously, the drawings in the following description are only for the application. In some embodiments, for those of ordinary skill in the art, without paying any creative labor, other drawings may be obtained based on these drawings, in which:

FIG. 1 is a schematic diagram of a distribution of a winding switching section of a coil in the related technology.

FIG. 2 is a cross-sectional view taken along line A-A in FIG. 1.

FIG. 3 shows a schematic diagram of a distribution of winding switching sections of a coil of the present invention.

FIG. 4 shows a structure of the coil of the present invention.

FIG. 5 illustrates a speaker module of the present invention.

FIG. 6 is an exploded view of the speaker module in FIG. 5.

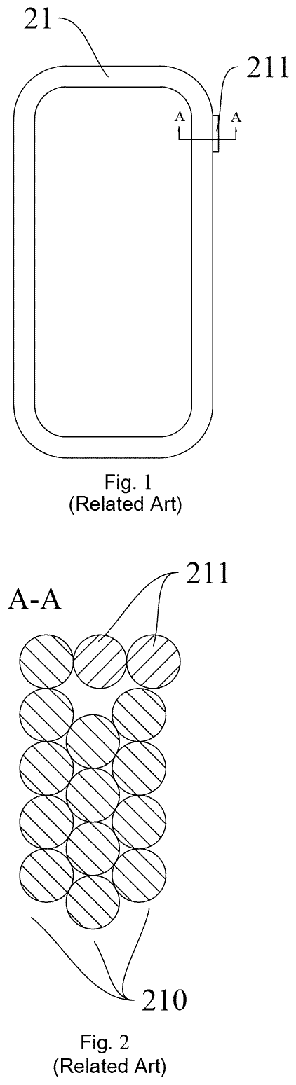

### DETAILED DESCRIPTION OF THE EMBODIMENTS

The following will be taken in conjunction with the accompanying drawings of embodiments of the present invention, The technical scheme in the embodiment of the invention is clearly and completely described, Obviously, the described embodiments are merely part of the embodiments of the present invention, and not all embodiments are based on the embodiments of the present invention, and all other embodiments attained by those of ordinary skill in the art without inventive effort are within the scope of the present invention.

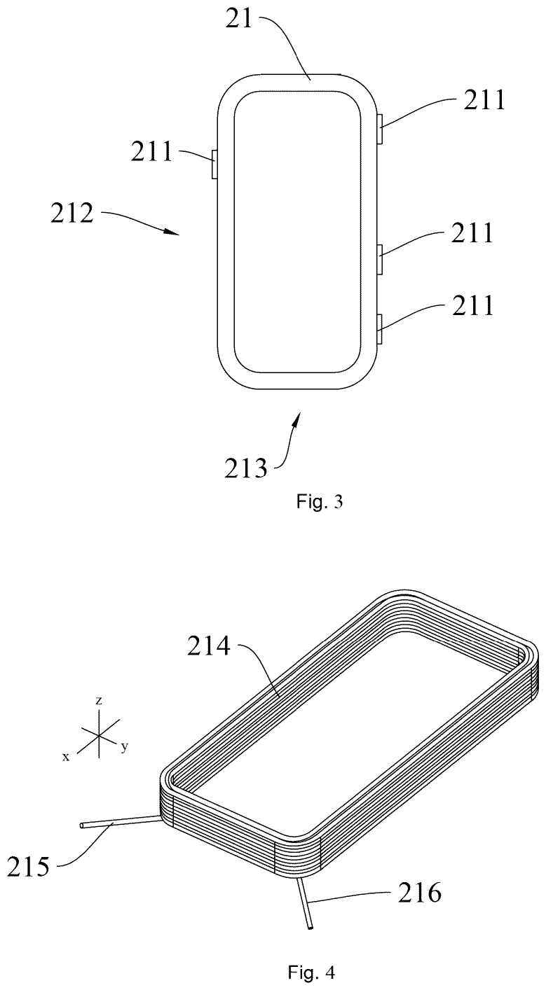

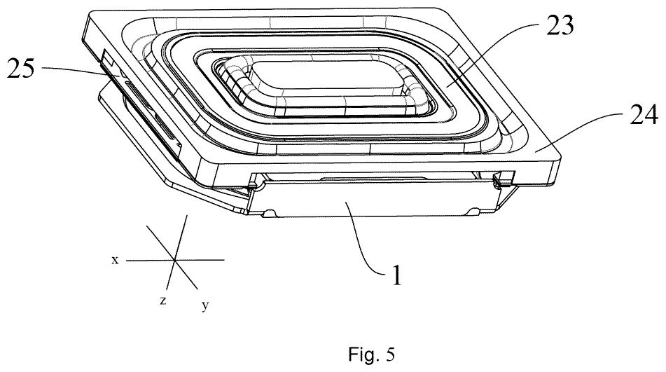

As shown in FIGS. 3 and 4, the present invention provides a coil. The coil 21 comprises N layers 210 of windings wound around a first axis (Z-axis) from the inside to the outside, where N is an integer greater than one. The adjacent winding layers 210 are connected by winding switch sections 211 that are dispersed along the winding path of the coil 21. Each winding switch sections 211 is arranged along the first axis (Z-axis) such that the projections of the winding switch sections on the plane (XY Plane) perpendicular to the first axis do not overlap.

The setting position of the winding switch portion 211 between the adjacent winding layers 210 of the coil 21 of the present invention is adjusted so that the winding switch sections 211 are staggered and each winding switch portion 211 does not overlap in the z-direction projection on the XY Plane, the dispersed setting of the positions of the winding switch sections 211 avoids the concentrated arrangement in the thickness direction of the coil 21, reduces the overall wall thickness of the coil 21, reduces the magnetic air gap, and improves the conversion efficiency and sensitivity of the speaker component.

The direction inside refers to the direction near the center axis of the coil 21, and the direction outside refers to the direction away from the center of the coil 21; the x, y, and z directions are mutually perpendicular in space, with the z direction being parallel to the vibration direction. Optionally, when the number of layers of the winding layer 210 of the coil 21 is N, the number of settings of the winding switching section 211 is N-1, where N is an integer greater than 1; for example, in some embodiments, when the number of layers of the winding layer 210 in the coil 21 is set to 5 layers, the number of settings of the winding switching section 211 is 4; optionally, the winding switching section 211 is distributed along the long side 212 of the coil 21.

Optionally, the winding switching section 211 is dispersedly arranged in the same XY Plane.

As shown in FIG. 3, the coil 21 is generally square in shape and includes a long side 212 and a short side 213 connected between the long sides 212. The winding switch section 211 is located on the long side 212 of the coil 21. In some embodiments, the long side 212 is parallel to the x-axis and the short side 213 is parallel to the y-axis.

As shown in FIG. 4, the winding layer 210 is connected from the inside to the outside to form the coil body 214, and the coil 21 also includes the coil input end 215 and the coil output end 216 connected respectively to the two ends of the coil body 214.

The coil 21 is made of enameled wire, and the conductor core of the enameled wire is made of copper core, aluminum core, copper-aluminum alloy core, or copper-clad aluminum wire.

The diameter of the conductive wire core is 0.02-0.15 mm, and the thickness of the insulation layer of the enameled wire is less than or equal to 0.02 mm.

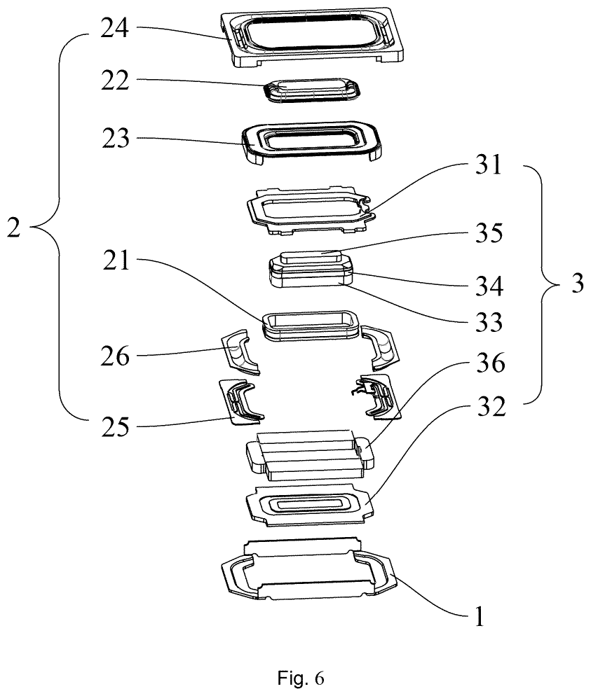

On the second aspect, the present invention provides a speaker module, as shown in FIGS. 5 and 6, the speaker module comprising a frame 1, a vibrating system 2, and a magnetic circuit system 3 accommodated in the frame 1, wherein the vibrating system 2 comprises the coil 21 as described above.

The magnetic circuit system 3 includes upper clamp plate 31 and lower clamp plate 32 which are set relative and spaced apart, inner magnet 33, pole core 34 and outer magnet 35 which are set on the lower clamp plate 32, and edge magnet 36 which is spaced apart and set around the outer periphery of the inner magnet 33; a magnetic gap is formed between the inner magnet 33 and the edge magnet 36, the coil 21 is placed in the magnetic gap, and the inner magnet 33, pole core 34 and outer magnet 35 are successively arranged from bottom to top on the lower clamp plate 32.

The vibrating system 2 further includes an inner diaphragm 22 located above the outer magnet 35, a frame 23 located at the outer periphery of the inner diaphragm 22, an upper diaphragm 24 set along the outer periphery of the frame 23, a flexible circuit board 25 located below the upper diaphragm 24, and a lower diaphragm 26 located below the flexible circuit board 25, the flexible circuit board 25 is conductive with the coil 21, the frame 23 is connected to the flexible circuit board 25 to support the vibrating system 2 on the flexible circuit board 25.

The coil 21 is connected to the framework 23 through the coil input end 215 and the coil output end 216, and is conductively connected to the flexible circuit board 25 through the framework. It should be noted that the direction up refers to the direction away from the lower clamping plate 32 in the z direction, and the direction down refers to the direction towards the lower clamping plate 32 in the z direction.

The foregoing is merely illustrative of embodiments of the present invention, and it should be noted that modifications may be made to those skilled in the art without departing from the spirit of the invention but are intended to be within the scope of the invention.

What is claimed is:

1. A coil for a speaker module, including N layers of winding layers wound from an inside to an outside around a first axis, where N is an integer greater than 1, wherein adjacent winding layers are connected by winding switch sections, the winding switch sections are scattered along a winding path of the coil, and each winding switch section along a projection of the first axis on a plane perpendicular to the first axis does not overlap with another.

2. The coil as described in claim 1, wherein the winding switching section is dispersedly arranged in the same plane perpendicular to the first axis.

3. The coil as described in claim 1, wherein the coil as a whole is square-shaped, including long sides and short sides connected between the long sides, and the winding switching section is located on the long side of the coil.

4. The coil as described in claim 1, wherein the winding layer is connected from the inside to the outside for forming the coil body, and the coil further includes a coil input end and a coil output end respectively connected to the two ends of the coil body.

5. The coil as described in claim 1, wherein the coil is wound with enameled wire, and a conductor core of the enameled wire is made of copper core, aluminum core, copper-aluminum alloy core, or copper-clad aluminum wire.

6. The coil as described in claim 5, wherein a diameter of the conductive wire core is 0.02-0.15 mm, and an insulation thickness of the enameled wire is less than or equal to 0.02 mm.

7. A speaker module, including:
a frame;
a vibration system;
and a magnetic circuit system accommodated in the frame; wherein
the vibration system includes a coil including N layers of winding layers wound from an inside to an outside around a first axis, where N is an integer greater than 1; and wherein
adjacent winding layers are connected by winding switch sections, the winding switch sections are scattered along a winding path of the coil, and each winding switch section along a projection of the first axis on a plane perpendicular to the first axis does not overlap with another.

8. The speaker module as described in claim 7, wherein the magnetic circuit system comprises a upper yoke plate, a lower yoke plate spaced from the upper yoke plate, an inner magnet, a pole core, an outer magnet arranged on the lower yoke plate, and an edge magnet arranged along a circumference of the inner magnet, for forming a magnetic gap between the inner magnet and the edge magnet for disposing the coil; and the inner magnet, the pole core, and the outer magnet are successively arranged on the lower yoke plate from a bottom to a top.

9. The speaker module as described in claim 7, wherein the vibration system further comprises an inner diaphragm located above the outer magnet, a frame located at an outer periphery of the inner diaphragm, an upper diaphragm arranged along an outer periphery of the frame, a flexible circuit board located below the upper diaphragm, and a lower diaphragm located below the flexible circuit board, wherein the flexible circuit board communicates with the coil, the frame is connected to the flexible circuit board for supporting the vibration system on the flexible circuit board.
